(19) United States
(12) Patent Application Publication
(10) Pub. No.: US 2026/0304038 A1
(43) Pub. Date: Oct. 1, 2026

(54) APPARATUS AND METHOD FOR OWN VOICE SUPPRESSION

(71) Applicant: Realtek Semiconductor Corporation, Hsinchu (TW)

(72) Inventors: Shih-Chieh HUANG, Hsinchu (TW); Chun-Ming YANG, Hsinchu (TW)

(21) Appl. No.: 19/434,002

(22) Filed: Dec. 29, 2025

(30) Foreign Application Priority Data
Apr. 1, 2025 (TW) 114112670

(51) Int. Cl. H04R 3/02; H04R 1/10

(52) U.S. Cl. CPC H04R 3/02; H04R 1/10

(57) ABSTRACT

An own voice suppression method includes: receiving a first audio signal and a second audio signal; receiving the first audio signal and utilizing an optimal filter to generate a third audio signal according to a set of optimal filter coefficients; subtracting the third audio signal from the second audio signal to obtain an error signal; converting the error signal and an omnidirectional signal into an error frequency domain signal and an omnidirectional frequency domain signal, respectively, in which the omnidirectional signal is the first audio signal or the second audio signal or a linear combination of the first audio signal and the second audio signal; calculating an amplitude ratio of the error frequency domain signal to the omnidirectional frequency domain signal in each frequency band; and determining a compression ratio of each frequency band according to the amplitude ratio of each frequency band.

### CROSS-REFERENCE TO RELATED APPLICATION

This application claims priority to Taiwan Application Serial Number 114112670, filed Apr. 1, 2025, which is herein incorporated by reference in its entirety.

### BACKGROUND

### Field of Invention

The present disclosure relates to an own voice suppression apparatus and an own voice suppression method. More particularly, the present disclosure relates to an apparatus and a method for own voice suppression based on spectrum analysis.

### Description of Related Art

Own voice suppression is a necessary function of hearing aid(s) (or a personal sound amplifier product), and its effectiveness directly determines the market acceptance of the hearing aids. Generally, if there is no special treatment for own voice, the hearing aids will amplify all recorded sounds. When the wearer speaks, his or her own voice will be transmitted through the skull to the ear canal, causing an aural fullness feeling, and/or his or her own voice will be transmitted to the hearing aids through the air, and the wearer may feel uncomfortable because the amplified own voice is too loud. The aural fullness feeling may be solved by releasing the sound pressure, but the amplified uncomfortable own voice often forces the wearer to lower the volume of the hearing aid, resulting in limited actual hearing aid effect.

If the hearing aids are equipped with the own voice suppression function, the own voice may be suppressed when it is well detected. In this case, the hearing aids may accordingly increase the overall volume, thereby achieving better hearing aid effect.

One of the known technologies of own voice suppression requires an additional configuration of bone conduction sensors to detect the presence of own voice, so that the own voice suppression can be performed when the presence of own voice is detected. However, the additional configuration of the bone conduction sensors will increase the cost of the hearing aids, and the installation position of the bone conduction sensors in the target cavity will affect the effect of receiving audio signal, increasing the difficulty to design the target cavity.

Other known technologies for own voice suppression have some disadvantages, such as a requirement of additional configuration of in-ear microphones, or a requirement of using high-computation blind source separation (BSS) algorithm, or a requirement of using artificial intelligence voiceprint recognition technology with high computational load and high storage demand, or a requirement of a large amount of data that needs to be exchanged between the two hearing aids, or a requirement of using more than two sets of adaptive filters, or a requirement of dynamically adjusting gain, or a requirement of dynamically adjusting beamformer, or a combination of at least two of the aforementioned issues. These disadvantages may cause shortcomings such as increased cost, high computational load, high storage demand, large amount of data exchange between the two hearing aids, and the algorithm may be difficult to converge, and/or the algorithm may not respond swiftly.

Therefore, it is necessary to develop an own voice suppression algorithm that can perform algorithmic process on the audio signal output by out-of-ear sound receivers (or out-of-ear microphones), which are essential for general hearing aids or wireless earbuds. At the same time, the own voice suppression algorithm must be simple, occupy low computational load and low storage demand, and can be widely used in most hearing aids or wireless earbuds on the market.

### SUMMARY

The present disclosure provides an own voice suppression apparatus. The own voice suppression apparatus includes a first sound receiver, a second sound receiver, an optimal filter, a subtractor, a frequency domain converter, a spectrum comparator, and a compression ratio determiner. The first sound receiver outputs a first audio signal. The second sound receiver outputs a second audio signal. The optimal filter is communicatively connected to the first sound receiver to receive the first audio signal and generate a third audio signal according to a set of optimal filter coefficients. The subtractor is communicatively connected to the second sound receiver and the optimal filter to subtract the third audio signal from the second audio signal to obtain an error signal. The frequency domain converter is communicatively connected to the subtractor to respectively convert the error signal and an omnidirectional signal into an error frequency domain signal and an omnidirectional frequency domain signal. The omnidirectional signal is the first audio signal or the second audio signal or a linear combination of the first audio signal and the second audio signal. The spectrum comparator is communicatively connected to the frequency domain converter to calculate an amplitude ratio of the error frequency domain signal to the omnidirectional frequency domain signal in each frequency band. The compression ratio determiner is communicatively connected to the spectrum comparator to determine a compression ratio of each frequency band according to the amplitude ratio of each frequency band.

The present disclosure further provides an own voice suppression method. The own voice suppression method includes: receiving a first audio signal from a first sound receiver and receiving a second audio signal from a second sound receiver; receiving the first audio signal and utilizing an optimal filter to generate a third audio signal according to a set of optimal filter coefficients; subtracting the third audio signal from the second audio signal to obtain an error signal; converting the error signal and an omnidirectional signal into an error frequency domain signal and an omnidirectional frequency domain signal, respectively, in which the omnidirectional signal is the first audio signal or the second audio signal or a linear combination of the first audio signal and the second audio signal; calculating an amplitude ratio of the error frequency domain signal to the omnidirectional frequency domain signal in each frequency band; and determining a compression ratio of each frequency band according to the amplitude ratio of each frequency band.

The present disclosure proposes a method for analyzing the presence of own voice and determining a compression ratio of each frequency band based on the analyzed results. The present disclosure can perform algorithmic process on the audio signal output by out-of-ear sound receivers (i.e., a first sound receiver and a second sound receiver), which are essential for general hearing aids or wireless earbuds. At the same time, the own voice suppression algorithm occupies low computational load and low storage demand, so that the own voice suppression algorithm can be widely used in most hearing aids or wireless earbuds on the market.

In order to make the above features and advantages of the present disclosure more apparent and understandable, the following embodiments of the present disclosure, together with the accompanying drawings, are described in detail below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an own voice suppression apparatus according to some embodiments of the present disclosure.

FIG. 2 is a system block diagram of the signal processor of the own voice suppression apparatus according to some embodiments of the present disclosure.

FIG. 3 is a flowchart of the own voice suppression method according to some embodiments of the present disclosure.

### DETAILED DESCRIPTION

Specific embodiments of the present disclosure are further described in detail below with reference to the accompanying drawings. However, the embodiments described are not intended to limit the present disclosure and it is not intended for the description of operations to limit the order of implementation.

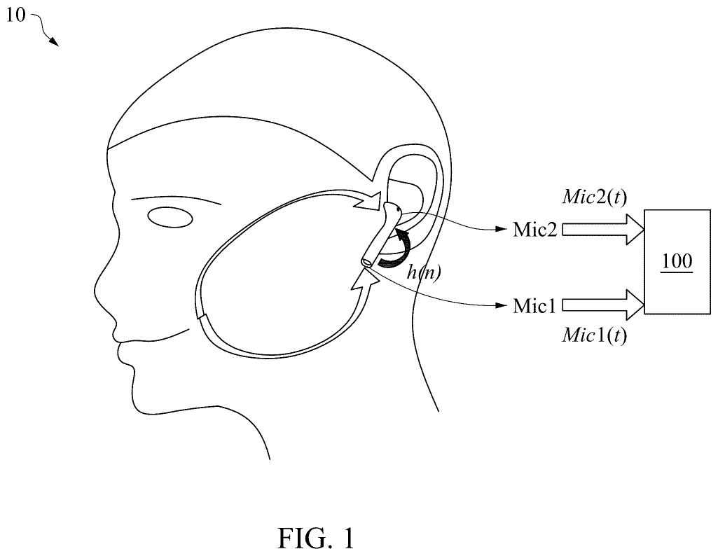

FIG. 1 is a diagram of an own voice suppression apparatus 10 according to some embodiments of the present disclosure. The own voice suppression apparatus 10 includes a first sound receiver Mic1, a second sound receiver Mic2, and a signal processor 100. In some embodiments of the present disclosure, the first sound receiver Mic1 and the second sound receiver Mic2 are out-of-ear sound receivers (or out-of-ear microphones). In some embodiments of the present disclosure, the signal processor 100 is an electronic component with computing capabilities such as a central processing unit (CPU), a microprocessor, a microcontroller, a digital signal processor (DSP), and an application specific integrated circuit (ASIC). In some embodiments of the present disclosure, the signal processor 100 may be communicatively connected to the first sound receiver Mic1 and the second sound receiver Mic2 via wired or wireless communication. The first sound receiver Mic1 outputs a first audio signal Mic1(t), and the second sound receiver Mic2 outputs a second audio signal Mic2(t). The signal processor 100 receives the first audio signal Mic1(t) from the first sound receiver Mic1 and receives the second audio signal Mic2(t) from the second sound receiver Mic2.

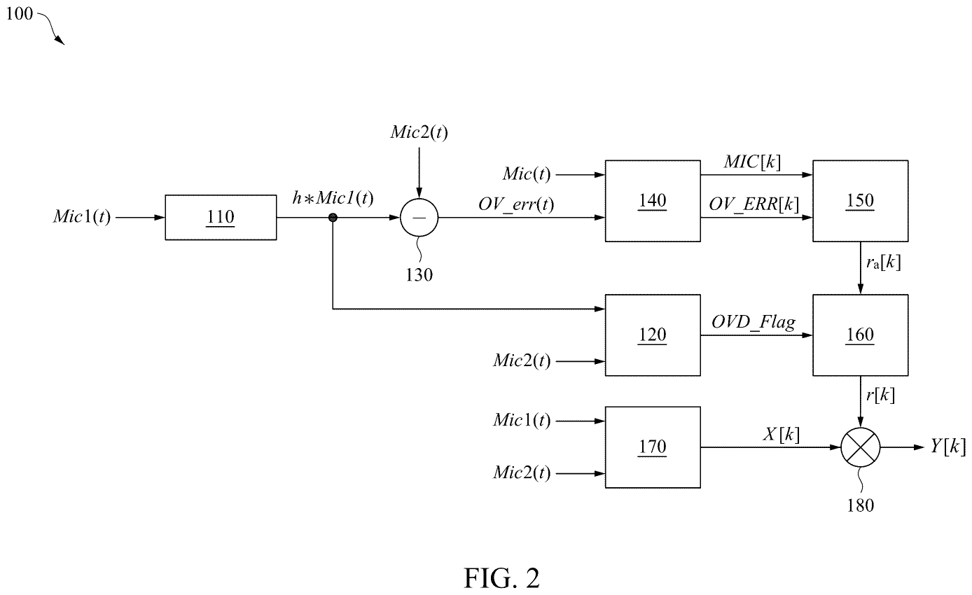

FIG. 2 is a system block diagram of the signal processor 100 of the own voice suppression apparatus 10 according to some embodiments of the present disclosure. The signal processor 100 includes an optimal filter 110, a similarity comparator 120, a subtractor 130, a frequency domain converter 140, a spectrum comparator 150, a compression ratio determiner 160, a signal processing unit 170, and a multiplier 180.

The optimal filter 110 is communicatively connected to the first sound receiver Mic1 to receive the first audio signal Mic1(t) and generate a third audio signal h*Mic1(t) according to a set of optimal filter coefficients. It is worth mentioning that the optimal filter 110 fixedly utilizes the set of optimal filter coefficients, and thus the optimal filter 110 is not an adaptive filter that needs to continuously update the filter coefficients. Accordingly, the own voice suppression method of some embodiments of the present disclosure has a fast response time and does not have the risk that the algorithm may not converge.

It should be noted that the signal processor 100 obtains the set of optimal filter coefficients through a training phase in advance. The process of the training phase is described as follows. First, the signal processor 100 receives the first sample audio signal from the first sound receiver Mic1 and receives the second sample audio signal from the second sound receiver Mic2. Next, the signal processor 100 performs a voice activity detection (VAD) based on the first sample audio signal and the second sample audio signal, thereby determining whether a voice activity is present at this time. If it is determined that the voice activity is not present at this time (i.e., a voice activity flag VAD_Flag=0), the first sample audio signal is continuously received from the first sound receiver Mic1, and the second sample audio signal is continuously received from the second sound receiver Mic2. If it is determined that the voice activity is present at this time (i.e., the voice activity flag VAD_Flag=1), the signal processor 100 trains the optimal filter 110 based on the first sample audio signal and the second sample audio signal, thereby finding the set of optimal filter coefficients h(n) for optimizing the optimal filter 110. The set of optimal filter coefficients h(n) reflects a frequency response difference between the two acoustic paths from a wearer's mouth to the first sound receiver Mic1 and to the second sound receiver Mic2, respectively.

The aforementioned VAD can ensure that the stage of finding the set of optimal filter coefficients h(n) is performed only when the VAD determines that the voice activity is present, so as to achieve more accurate convergence results. Specifically, the aforementioned VAD performs on the first sample audio signal and/or the second sample audio signal, and it can be set that when the result of the aforementioned VAD of the first sample audio signal and/or the second sample audio signal is “YES”, it is determined that the voice activity is present.

It should be noted that the aforementioned training phase is performed in a silent environment (in the present disclosure, the silent environment is defined as that in which a sound pressure level does not exceed 50 decibels) to ensure that the first sample audio signal received from the first sound receiver Mic1 and the second sample audio signal received from the second sound receiver Mic2 are originated from the wearer's mouth. In some embodiments of the present disclosure, during the training phase, the wearer utters several own voice sentences through the wearer's mouth, so that there will be several first sample audio signals and several second sample audio signals during the training phase. The signal processor 100 will utilize these sample audio signals to find the set of optimal filter coefficients h(n). It is worth mentioning that the aforementioned training phase usually only needs to be performed once and can be completed within a few seconds (e.g., within ten seconds).

The optimal filter 110 is configured to model the relative transfer function (i.e., the aforementioned frequency response difference between two acoustic paths) between the first sample audio signal received from the first sound receiver Mic1 and the second sample audio signal received from the second sound receiver Mic2.

The signal processor 100 finds the set of optimal filter coefficients h(n) according to an objective function shown in the following equation (1):

$${min}_{h} E [ {( Mic 2 - h * Mic 1 )}^{2} ] , \qquad ( 1 )$$

where h is a vector of filter coefficients, Mic1 is the first sample audio signal, Mic2 is the second sample audio signal, and E is a mathematical expectation (also called an expected value in mathematics). The set of optimal filter coefficients h(n) corresponds to the coefficients that make the objective function attains a minimum value. In other words, the set of optimal filter coefficients h(n) is found by optimizing the optimal filter 110 based on the objective function shown in the aforementioned equation (1). In some embodiments of the present disclosure, the signal processor 100 may find the set of optimal filter coefficients h(n) by utilizing any searching method, such as a least mean square error (LMSE) algorithm, a normalized least mean square error algorithm, or an adaptive least mean square error algorithm. The present disclosure does not restrict the searching method for finding the set of optimal filter coefficients h(n). Those skilled in the art should appreciate how to use the aforementioned example searching method to solve the optimized problem under the given objective function, and the process of finding the optimal filter coefficients will not be described in detail herein. If the embodiment described here is implemented in the time domain, then the symbol “*” in the aforementioned equation (1) is convolution; and if the embodiment described here is implemented in the frequency domain, then the symbol “*” in the aforementioned equation (1) is multiplication.

The signal processor 100 may find the set of optimal filter coefficients h(n) by the following manner.

The signal processor 100 may perform a mathematical operation on the first sample audio signal and the aforementioned relative transfer function to obtain a third sample audio signal. Then, the signal processor 100 finds the set of optimal filter coefficients h(n) by performing an optimization process with a goal to maximize the similarity index between the third sample audio signal and the second sample audio signal. The aforementioned similarity index can be defined by a cosine similarity or a correlation coefficient between the third sample audio signal and the second sample audio signal. If the embodiment described here is implemented in the time domain, the above mathematical operation is convolution. If the embodiment described here is implemented in the frequency domain, the above mathematical operation is multiplication.

Regarding the manner for finding the set of optimal filter coefficients h(n), the adaptive least mean square error algorithm is taken as an example here. After the n-th sample audio signal is read in, the error signal OV_err is calculated according to the following equation (2):

$$OV\_err = ( Mic 2 - h * Mic 1 ) ( n ) , \qquad ( 2 )$$

where h*Mic1 corresponds to the third sample audio signal. Then, the vector of filter coefficients h is updated according to the error signal OV_err, the updated manner is shown in the following equation (3):

$${h}^{′} = h + {μ}_{0} \cdot VAD\_flag \cdot OV\_err \cdot Mic 1 , \qquad ( 3 )$$

where h′ is the updated vector of filter coefficients. h and Mic₁ in the equation (3) are N-dimensional column vectors. That is, h=(h₀, h₁, . . . , h_{N-1})^{T}, and Mic1= (Mic1[n], Mic1[n−1], . . . , Mic1[n-N+1])^{T}. The convergence step factorμ₀ is a given positive number. When the voice activity flag VAD_flag=1, h′ is updated according to the equation (3). On the contrary, when the voice activity flag VAD_flag=0, h′ is not updated. The above case is an example for finding the set of optimal filter coefficients h(n) in the time domain. According to the above, in the silent environment where the sound pressure level does not exceed 50 decibels (i.e., in the training phase), the set of optimal filter coefficients h(n) are the coefficients that make the error signal OV_err attains a minimum value in amplitude.

Similarly, the set of optimal filter coefficients can also be found in the frequency domain. First, the discrete Fourier transform pairs are defined according to the following equations (4), (5) and (6):

$$h [ n ] ↔ H [ k ] , \qquad ( 4 )$$

$$Mic 1 [ n ] ↔ MIC 1 [ k ] , and \qquad ( 5 )$$

$$Mic 2 [ n ] ↔ MIC 2 [ k ] . \qquad ( 6 )$$

Then, the error signal OV_ERR[k] is calculated in each frame according to the following equation (7):

$$OV\_ERR [ k ] = ( MIC 2 [ k ] - H [ k ] \cdot MIC 1 [ k ] ) ( n ) , \qquad ( 7 )$$

Then, the set of optimal filter coefficients H[k] is updated according to the error signal OV_ERR[k], and the updated manner is shown in the following equation (8):

$${H}^{′} [ k ] = H [ k ] + {μ}_{0} \cdot VAD\_flag \cdot \vert {OV}_{ERR [ k ]} \vert \cdot MIC 1 [ k ] , \qquad ( 8 )$$

where H′[k] is the updated set of filter coefficients. When the voice activity flag VAD_flag=1, H′[k] is updated according to the equation (8). On the contrary, when the voice activity flag VAD_flag=0, H′[k] is not updated. The above case is an example for finding the set of optimal filter coefficients H[k] in the frequency domain.

The similarity comparator 120 is communicatively connected to the second sound receiver Mic2 (not shown) to receive the second audio signal Mic2(t). The similarity comparator 120 is communicatively connected to the optimal filter 110 to receive the third audio signal h*Mic1(t). The similarity comparator 120 compares a similarity index between the second audio signal Mic2(t) and the third audio signal h*Mic1(t) to generate an own voice flag OVD_flag. The own voice flag OVD_flag indicates whether the first sound receiver Mic1 and the second sound receiver Mic2 record own voice.

In some embodiments of the present disclosure, the aforementioned similarity index is a cosine similarity or a correlation coefficient. In other words, the aforementioned similarity index can be defined by the cosine similarity or the correlation coefficient between the second audio signal Mic2(t) and the third audio signal h*Mic1(t). When the similarity index is larger than a threshold, the own voice flag OVD_flag=1 indicates that the first sound receiver Mic1 and the second sound receiver Mic2 record own voice. When the similarity index is not larger than the threshold, the own voice flag OVD_flag=0 indicates that the first sound receiver Mic1 and the second sound receiver Mic2 do not record own voice. The aforementioned threshold can be a value set by the designer based on actual needs, such as 0.9995 or 0.999. The present disclosure does not restrict the value of the threshold.

In some embodiments of the present disclosure, the similarity index comparison method adopted by the similarity comparator 120 is based on the consistency of phase and amplitude, and therefore the similarity index comparison method is more reliable than the power comparison method that only relies on amplitude. The similarity index comparison method can be implemented in many ways, as shown below with an example.

First, the first audio signal Mic1(t) is input into and filtered by the optimal filter 110 with the set of optimal filter coefficients so as to obtain the third audio signal h*Mic1(t), and the third audio signal h*Mic1(t) is expressed as sig1 in the following equation (9). The second audio signal Mic2(t) is expressed as sig2 in the following equation (9). From the aspect of phase, the cosine similarity between sig1 and sig2 satisfies the following equation (9):

$$\frac{sig 1 \cdot sig 2}{{‖ sig 1 ‖}_{2} {‖ sig 2 ‖}_{2}} > threshold , \qquad ( 9 )$$

where the threshold can be set as 0.9995. The present disclosure does not restrict the value of the threshold. The subscript 2 in the above equation (9) represents L2-norm of the vector. sig1· sig2 is a short time inner product, as shown in equation (10):

$$sig 1 \cdot sig 2 = {\sum }_{i = 0}^{M - 1} sig 1 [ n - i ] \cdot sig 2 [ n - i ] , \qquad ( 10 )$$

where M is a positive integer. On the other hand, from the aspect of amplitude, the amplitude of sig1 should be comparable with the amplitude of sig2. For example, the amplitude of sig1 and the amplitude of sig2 satisfy the following equation (11):

$$sig 1 \cdot sig 2 > γ sig 2 \cdot sig 2 , \qquad ( 11 )$$

where γ is the threshold, which may be set as 0.999. The present disclosure does not restrict the value of the threshold γ.

Specifically, the purpose of similarity comparator 120 is to detect whether the wearer of the own voice suppression apparatus 10 is uttering his or her own voice and to accordingly suppress the hearing aid output, thereby providing a better wearer experience for the wearer.

Specifically, some of the known own voice detection methods usually directly perform signal analysis on the audio signals received by the sound receiver to determine whether own voice is present. In contrast, the present disclosure utilizes the optimal filter 110 with the set of optimal filter coefficients and the similarity comparator 120 to determine whether own voice is present. Therefore, the present disclosure can better improve the accuracy of own voice detection, reduce the computational load, and shorten the response time.

In some embodiments of the present disclosure, when the own voice suppression apparatus 10 is worn on a head of the wearer, the first sound receiver Mic1 and the second sound receiver Mic2 are both located at the same ear of the wearer (for example, the left ear of the wearer shown in FIG. 1). In some embodiments of the present disclosure, it should be noted that, as shown in FIG. 1, when the own voice suppression apparatus 10 is worn on the head of the wearer, the first sound receiver Mic1 is closer to the wearer's mouth than the second sound receiver Mic2. This is because compared to the second sound receiver Mic2, the first audio signal Mic1(t) received by the first audio receiver Mic1 needs to be input into the optimal filter 110, and then the related signal process (e.g., the similarity index comparison method) is performed on the filtered first audio signal (i.e., the third audio signal h*Mic1(t)) and the second audio signal Mic2(t) received by the second sound receiver Mic2. Therefore, the first sound receiver Mic1 is closer to the wearer's mouth than the second microphone Mic2, thereby better compensating the time delay introduced by the optimal filter 110.

The subtractor 130 is communicatively connected to the second sound receiver Mic2 (not shown) to receive the second audio signal Mic2(t). The subtractor 130 is communicatively connected to the optimal filter 110 to receive the third audio signal h*Mic1(t). The subtractor 130 subtracts the third audio signal h*Mic1(t) from the second audio signal Mic2(t) to obtain the error signal OV_err (t) (for example, refer to the above equation (2)).

Specifically, when the own voice flag OVD_flag=1, the second audio signal Mic2(t) and the third audio signal h*Mic1(t) are very similar signals, so the error signal OV_err (t) will be a signal with a relatively small amplitude. On the contrary, when the own voice flag OVD_flag=0, the second audio signal Mic2(t) and the third audio signal h*Mic1(t) are dissimilar signals, so the error signal OV_err (t) will be a signal with a relatively large amplitude. The relatively small/large amplitude mentioned here is relative to the amplitude of the first audio signal Mic1(t) or the second audio signal Mic2(t) at the same time.

The frequency domain converter 140 is communicatively connected to the first sound receiver Mic1 and/or the second sound receiver Mic2 (not shown) to receive the first audio signal Mic1(t) and/or the second audio signal Mic2(t). The frequency domain converter 140 is communicatively connected to the subtractor 130 to receive the error signal OV_err (t). The frequency domain converter 140 respectively converts the error signal OV_err (t) and an omnidirectional signal Mic (t) into an error frequency domain signal OV_ERR[k] and an omnidirectional frequency domain signal MIC[k] (for example, through fast Fourier transform (FFT)). The omnidirectional signal Mic (t) is the first audio signal Mic1(t) or the second audio signal Mic2(t) or a linear combination of the first audio signal Mic1(t) and the second audio signal Mic2(t).

The spectrum comparator 150 is communicatively connected to the frequency domain converter 140 to receive the error frequency domain signal OV_ERR[k] and the omnidirectional frequency domain signal MIC[k]. The spectrum comparator 150 calculates an amplitude ratio rₐ[k] (also called a power ratio) of the error frequency domain signal OV_ERR[k] to the omnidirectional frequency domain signal MIC[k] in each frequency band. The spectrum comparator 150 compares the power of the error frequency domain signal OV_ERR[k] and the power of the omnidirectional frequency domain signal MIC[k] in each frequency band. In other words, the spectrum comparator 150 performs spectrum analysis on the error frequency domain signal OV_ERR[k] and the omnidirectional frequency domain signal MIC[k].

For example, the spectrum comparator 150 calculates the amplitude ratio rₐ[k] according to the following equation (12):

$${r}_{a} [ k ] = frame - averaged \frac{\vert OV\_ERR [ k ] \vert}{\vert MIC [ k ] \vert} . \qquad ( 12 )$$

In other words, the spectrum comparator 150 performs spectrum analysis on the ratio of the error frequency domain signal OV_ERR[k] to the omnidirectional frequency domain signal MIC[k] to obtain a frame-averaged value of the power spectrum component of the ratio of the error frequency domain signal OV_ERR[k] to the omnidirectional frequency domain signal MIC[k].

The spectrum comparator 150 may calculate the amplitude ratio rₐ[k] by the following manner.

Whenever the error frequency domain signal OV_ERR[k] and the omnidirectional frequency domain signal MIC[k] are obtained, the exponential moving average of the absolute value of the error frequency domain signal OV_ERR[k] is calculated according to the following equation (13), and the exponential moving average of the absolute value of the omnidirectional frequency domain signal MIC[k] is calculated according to the following equation (14):

$$smooth\_OV \_ERR [ k ] = β \cdot smooth\_OV \_ERR [ k ] + ( 1 - β ) \cdot ‖ OV\_ERR [ k ] ‖ , \qquad ( 13 )$$

$$smooth\_MIC [ k ] = β \cdot smooth\_MIC [ k ] + ( 1 - β ) \cdot ‖ OV\_ERR [ k ] ‖ , \qquad ( 14 )$$

where β is, for example, 0.7.

Then, the amplitude ratio rₐ[k] is calculated according to the following equation (15):

$${r}_{a} [ k ] = \frac{smooth\_OV \_ERR [ k ]}{smooth\_MIC [ k ]} . \qquad ( 15 )$$

The compression ratio determiner 160 is communicatively connected to the spectrum comparator 150 to receive the amplitude ratio rₐ[k] of the error frequency domain signal OV_ERR[k] to the omnidirectional frequency domain signal MIC[k] in each frequency band. The compression ratio determiner 160 determines a compression ratio r[k] of each frequency band according to the amplitude ratio rₐ[k] of each frequency band.

The compression ratio determiner 160 is communicatively connected to the similarity comparator 120 to receive the own voice flag OVD_flag. The compression ratio determiner 160 determines the compression ratio r[k] of each frequency band according to the own voice flag OVD_flag and the amplitude ratio rₐ[k] of each frequency band. Specifically, the compression ratio determiner 160 determines the proportion of how much own voice is present in each frequency band according to the own voice flag OVD_flag and the amplitude ratio rₐ[k], thereby calculating the ratio that the received audio signal is required to be compressed in each frequency band (i.e., the compression ratio r[k]) accordingly.

In some embodiments of the present disclosure, the compression ratio determiner 160 performs a smoothing process on the amplitude ratio rₐ[k] of each frequency band to obtain the compression ratio r[k] of each frequency band. The aforementioned smoothing process may be achieved through the following operations. When the own voice flag OVD_flag indicates that the first sound receiver Mic1 and the second sound receiver Mic2 record own voice (i.e., the own voice flag OVD_flag=1), the compression ratio r[k] is adjusted to approach the amplitude ratio rₐ[k]. In contrast, when the own voice flag OVD_flag indicates that the first sound receiver Mic1 and the second sound receiver Mic2 do not record own voice (i.e., the own voice flag OVD_flag=0), the compression ratio r[k] is adjusted to approach 1.

The compression ratio r[k] is adjusted to approach the amplitude ratio rₐ[k] according to the following equation (16):

$$r [ k ] = α \cdot r [ k ] + ( 1 - α ) \cdot {r}_{a} [ k ] . \qquad ( 16 )$$

The compression ratio r[k] is adjusted to approach 1 according to the following equation (17):

$$r [ k ] = α \cdot r [ k ] + ( 1 - α ) \cdot 1 , \qquad ( 17 )$$

where α is a value less than and close to 1, for example, α=0.9.

Specifically, the compression ratio r[k] is a value between the amplitude ratio rₐ[k] and 1, and the compression ratio r[k] is a value that is continuously adjusted. The preset value of the compression ratio r[k] is a value set by the designer based on actual needs. When the own voice flag OVD_flag=1, the received audio signal should be compressed more because own voice is present, so the compression ratio r[k] will be closer to the amplitude ratio rₐ[k]. On the other hand, when the own voice flag OVD_flag=0, the received audio signal should be compressed less because own voice is not present, so the compression ratio r[k] will be closer to 1.

The signal processing unit 170 is communicatively connected to the first sound receiver Mic1 and the second sound receiver Mic2 (not shown) to receive the first audio signal Mic1(t) and the second audio signal Mic2(t). The signal processing unit 170 optionally performs beamforming on the first audio signal Mic1(t) and the second audio signal Mic2(t), and optionally performs noise suppression, and then converts the first audio signal Mic1(t) and the second audio signal Mic2(t) from time domain to frequency domain (for example, through a fast Fourier transform FFT) to obtain a frequency domain signal to be suppressed X[k]. In other words, the frequency domain signal to be suppressed X[k] is obtained by converting the first audio signal Mic1(t) and the second audio signal Mic2(t) from time domain to frequency domain, optionally through or without beamforming, and optionally through or without noise suppression.

The multiplier 180 is communicatively connected to the compression ratio determiner 160 to receive the compression ratio r[k] and communicatively connected to 170 to receive the frequency domain signal to be suppressed X[k]. The multiplier 180 multiplies the frequency domain signal to be suppressed X[k] by the compression ratio r[k] to generate a suppressed frequency domain signal Y[k]. In other words, the audio signal to be suppressed is multiplied by the compression ratio r[k] to obtain the suppressed audio signal, thus completing the operation of own voice suppression.

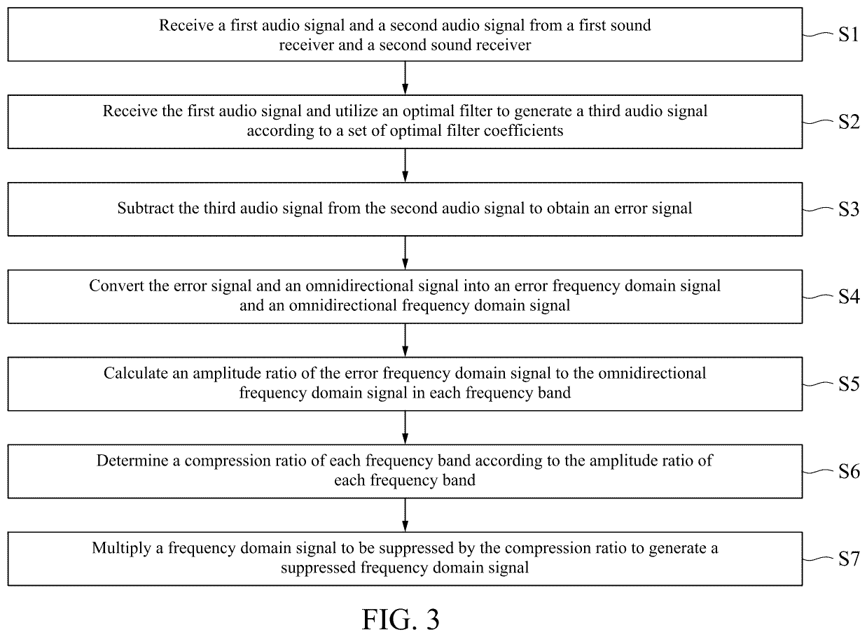

FIG. 3 is a flowchart of the own voice suppression method according to some embodiments of the present disclosure. In step S1, the signal processor 100 receives the first audio signal Mic1(t) from the first sound receiver Mic1 and receives the second audio signal Mic2(t) from the second sound receiver Mic2. In step S2, the optimal filter 110 receives the first audio signal Mic1(t) and generates the third audio signal h*Mic1(t) according to the set of optimal filter coefficients h(n). In step S3, the subtractor 130 subtracts the third audio signal h*Mic1(t) from the second audio signal Mic2(t) to obtain the error signal OV_err (t). In step S4, the frequency domain converter 140 respectively converts the error signal OV_err (t) and the omnidirectional signal Mic (t) into the error frequency domain signal OV_ERR[k] and the omnidirectional frequency domain signal MIC[k]. In step S5, the spectrum comparator 150 calculates the amplitude ratio rₐ[k] of the error frequency domain signal OV_ERR[k] to the omnidirectional frequency domain signal MIC[k] in each frequency band. In step S6, the compression ratio determiner 160 determines the compression ratio r[k] of each frequency band according to the amplitude ratio rₐ[k] of each frequency band. In step S7, the multiplier 180 multiplies the frequency domain signal to be suppressed X[k] by the compression ratio r[k] to generate the suppressed frequency domain signal Y[k].

In some embodiments of the present disclosure, as mentioned above, the first sound receiver Mic1 and the second sound receiver Mic2 are both located at the same ear of the wearer. Therefore, the own voice suppression apparatus 10 proposed by the present disclosure can be operated independently for one ear. On the other hand, in some other embodiments of the present disclosure, the function of exchanging data between two sound receivers may be added, that is, another set of own voice suppression apparatus is configured in the other ear of the wearer. These two sets of the own voice suppression apparatus may work together, and only when both the two sets of the own voice suppression apparatus determine that own voice is present, own voice is determined to be present. This will improve the accuracy of own voice suppression by binaural hearing aids.

To sum up, the present disclosure proposes a method for analyzing the presence of own voice and determining a compression ratio of each frequency band based on the analyzed results. The present disclosure can perform algorithmic process on the audio signal output by out-of-ear sound receivers (i.e., a first sound receiver and a second sound receiver) which are essential for general hearing aids or wireless earbuds. At the same time, the own voice suppression algorithm has advantages of high accuracy, low computational load, short response time, and low storage demand, and the own voice suppression apparatus can be operated independently for one ear, so that the own voice suppression algorithm can be widely used in most hearing aids or wireless earbuds on the market.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. An own voice suppression apparatus, comprising:
a first sound receiver configured to output a first audio signal;
a second sound receiver configured to output a second audio signal; and
an optimal filter communicatively connected to the first sound receiver to receive the first audio signal and generate a third audio signal according to a set of optimal filter coefficients;
a subtractor communicatively connected to the second sound receiver and the optimal filter to subtract the third audio signal from the second audio signal to obtain an error signal;
a frequency domain converter communicatively connected to the subtractor to respectively convert the error signal and an omnidirectional signal into an error frequency domain signal and an omnidirectional frequency domain signal, wherein the omnidirectional signal is the first audio signal or the second audio signal or a linear combination of the first audio signal and the second audio signal;
a spectrum comparator communicatively connected to the frequency domain converter to calculate an amplitude ratio of the error frequency domain signal to the omnidirectional frequency domain signal in each frequency band; and
a compression ratio determiner communicatively connected to the spectrum comparator to determine a compression ratio of each frequency band according to the amplitude ratio of each frequency band.

2. The own voice suppression apparatus of claim 1, wherein the compression ratio determiner performs a smoothing process on the amplitude ratio of each frequency band to obtain the compression ratio of each frequency band.

3. The own voice suppression apparatus of claim 2, further comprising:
a similarity comparator communicatively connected to the second sound receiver and the optimal filter to compare a similarity index between the second audio signal and the third audio signal to generate an own voice flag;
wherein the own voice flag indicates whether the first sound receiver and the second sound receiver record own voice;
wherein the compression ratio determiner determines the compression ratio of each frequency band according to the own voice flag and the amplitude ratio of each frequency band.

4. The own voice suppression apparatus of claim 3, wherein the smoothing process comprises:
adjusting the compression ratio to approach the amplitude ratio, in response to the own voice flag indicating that the first sound receiver and the second sound receiver record own voice; and
adjusting the compression ratio to approach 1, in response to the own voice flag indicating that the first sound receiver and the second sound receiver do not record own voice.

5. The own voice suppression apparatus of claim 4,
wherein a formula for adjusting the compression ratio to approach the amplitude ratio is as follows:
$$[ k ] = α \cdot r [ k ] + ( 1 - α ) \cdot {r}_{a} [ k ] ;$$
wherein a formula for adjusting the compression ratio to approach 1 is as follows:
$$r [ k ] = α \cdot r [ k ] + ( 1 - α ) \cdot 1 ;$$
wherein rₐ[k] is the amplitude ratio, r[k] is the compression ratio, α is a value less than and close to 1.

6. The own voice suppression apparatus of claim 1, further comprising:
a multiplier communicatively connected to the compression ratio determiner to multiply a frequency domain signal to be suppressed by the compression ratio to generate a suppressed frequency domain signal.

7. The own voice suppression apparatus of claim 6, wherein the frequency domain signal to be suppressed is obtained by converting the first audio signal and the second audio signal from time domain to frequency domain, optionally through or without beamforming, and optionally through or without noise suppression.

8. The own voice suppression apparatus of claim 1, wherein the optimal filter is trained in an environment with a sound pressure level not exceeding 50 decibels, wherein the set of optimal filter coefficients are coefficients that make the error signal attains a minimum value in amplitude.

9. The own voice suppression apparatus of claim 3, wherein the similarity index is a cosine similarity or a correlation coefficient between the second audio signal and the third audio signal, wherein in response to the similarity index larger than a threshold, the own voice flag indicates that the first sound receiver and the second sound receiver record own voice.

10. The own voice suppression apparatus of claim 1, wherein the own voice suppression apparatus is worn on a head of a wearer, and the first sound receiver and the second sound receiver are located at the same ear of the wearer.

11. The own voice suppression apparatus of claim 10, wherein the first sound receiver is closer to the mouth of the wearer than the second sound receiver.

12. An own voice suppression method, comprising:
receiving a first audio signal from a first sound receiver and receiving a second audio signal from a second sound receiver;
receiving the first audio signal and utilizing an optimal filter to generate a third audio signal according to a set of optimal filter coefficients;
subtracting the third audio signal from the second audio signal to obtain an error signal;
converting the error signal and an omnidirectional signal into an error frequency domain signal and an omnidirectional frequency domain signal, respectively, wherein the omnidirectional signal is the first audio signal or the second audio signal or a linear combination of the first audio signal and the second audio signal;
calculating an amplitude ratio of the error frequency domain signal to the omnidirectional frequency domain signal in each frequency band; and
determining a compression ratio of each frequency band according to the amplitude ratio of each frequency band.

13. The own voice suppression method of claim 12, further comprising:
performing a smoothing process on the amplitude ratio of each frequency band to obtain the compression ratio of each frequency band.

14. The own voice suppression method of claim 13, further comprising:
comparing a similarity index between the second audio signal and the third audio signal to generate an own voice flag, wherein the own voice flag indicates whether the first sound receiver and the second sound receiver record own voice; and
determining the compression ratio of each frequency band according to the own voice flag and the amplitude ratio of each frequency band.

15. The own voice suppression method of claim 14, wherein smoothing process comprises:
adjusting the compression ratio to approach the amplitude ratio, in response to the own voice flag indicating that the first sound receiver and the second sound receiver record own voice; and
adjusting the compression ratio to approach 1, in response to the own voice flag indicating that the first sound receiver and the second sound receiver do not record own voice.

16. The own voice suppression method of claim 15,
wherein a formula for adjusting the compression ratio to approach the amplitude ratio is as follows:
$$r [ k ] = α \cdot r [ k ] + ( 1 - α ) \cdot {r}_{a} [ k ] ;$$
wherein a formula for adjusting the compression ratio to approach 1 is as follows:
$$r [ k ] = α \cdot r [ k ] + ( 1 - α ) \cdot 1 ;$$
wherein rₐ[k] is the amplitude ratio, r[k] is the compression ratio, α is a value less than and close to 1.

17. The own voice suppression method of claim 12, further comprising:
multiplying a frequency domain signal to be suppressed by the compression ratio to generate a suppressed frequency domain signal.

18. The own voice suppression method of claim 17, wherein the frequency domain signal to be suppressed is obtained by converting the first audio signal and the second audio signal from time domain to frequency domain, optionally through or without beamforming, and optionally through or without noise suppression.

19. The own voice suppression method of claim 12, wherein the optimal filter is trained in an environment with a sound pressure level not exceeding 50 decibels, wherein the set of optimal filter coefficients are coefficients that make the error signal attains a minimum value in amplitude.

20. The own voice suppression method of claim 14, wherein the similarity index is a cosine similarity or a correlation coefficient between the second audio signal and the third audio signal, wherein in response to the similarity index larger than a threshold, the own voice flag indicates that the first sound receiver and the second sound receiver record own voice.
